(19) United States
(12) Patent Application Publication
(10) Pub. No.: US 2009/0218333 A1
(43) Pub. Date: Sep. 3, 2009

(54) HEATING ELEMENT FOR APPLICATION IN A DEVICE FOR HEATING LIQUIDS

(75) Inventor: Simon Kaastra, Dinxperlo (NL)

Correspondence Address: BRYAN CAVE POWELL GOLDSTEIN, ONE ATLANTIC CENTER FOURTEENTH FLOOR, 1201 WEST PEACHTREE STREET NW, ATLANTA, GA, 30309-3488, US

(73) Assignee: FERRO TECHNIEK HOLDING B.V., AT Gaanderen (NL)

(21) Appl. No.: 11/995,455

(22) PCT Filed: Jul. 7, 2006
(86) PCT No.: PCT/NL06/50168

§ 371 Date: Dec. 11, 2008

(30) Foreign Application Priority Data
Jul. 11, 2005 (NL) 1029484

(51) Int. Cl. H05B 3/12; H05B 3/26; A47J 36/26

(52) U.S. Cl. 219/438; 219/553

(57) ABSTRACT

A heating element for use in a device for heating liquids comprising an uninterrupted and integrally constructed track-like electrical resistor having a first material for forced conduction of electric current, electrical resistor having a plurality of elongate resistor segments and at least one curved resistor segment for mutual electrical coupling of the elongate resistor segments. Also disclosed is a device for heating liquids using the heating element.

### PRIORITY CLAIM

This patent application is a U.S. National Phase of International Patent Application No. PCT/NL2006/050168, filed Jul. 7, 2006, which claims priority to Netherlands Patent Application No. 1029484, filed Jul. 11, 2005, the disclosures of which are incorporated herein by reference in their entirety.

### FIELD

The present disclosure relates to a heating element for use in a device for heating a medium, in particular a liquid. The present disclosure also relates to a device for heating a medium, in particular a liquid, the device comprising a heating element according to the present disclosure.

### BACKGROUND

It is known to heat liquids by means of a heating element comprising a track-like electrical resistor. Heat is generated by conducting electric current through the resistor. The heat can then be utilized to heat a liquid. The electrical resistor will usually be arranged as a thick film on an electrically insulating base. The surface is generally formed by a substrate on which a dielectric is arranged. In order to maximize the power density of the heating element, it is important to optimize the design of the topography of the thick film, wherein it is the general objective to maximize the surface area printed with the thick film. The freedom of design is, however, limited here by multiple preconditions that have to be taken into account.

Firstly, the thick film must be designed such that adjacent sections of the thick film are positioned at a mutual distance so as to be able to prevent short-circuiting in the heating element. Furthermore, the design of an optimal layout of the thick film is limited by so-called “current crowding.” According to this phenomenon, electric current tends to choose the path of least resistance as the electric current passes through the thick film. Particularly, in considerable curves (bends) in the thick film the current will, in general, substantially prefer the inside bend of the curve to the outside bend, whereby a significant increase in the local current density will occur in the inside bend, which results in significant local heat generation in the heating element, whereby the heating element will generally fail relatively quickly. A solution to this problem is provided in European Patent Application No. 1 013 148, which describes an improved heating element wherein the thick film comprises a plurality of discrete, elongate resistor segments which are mutually coupled at the outer ends by means of highly conductive bridges. Each bridge is manufactured from an electrically highly conductive material, preferably comprising silver, through which electric current can move relatively easily and relatively unobstructed. In this manner, a significant increase in the local current density, and associated considerable heat generation, can be prevented. In addition to the advantage of the heating element described in European Patent Application No. 1 013 148, this heating element also has a number of drawbacks. Tests have shown that, during or just after applying the material layer or during drying or firing of the material layer to the substrate and to the outer ends of adjacent elongate resistor segments, the highly conductive, silver-comprising material layer will usually contract as a result of cohesion such that gaps will occur in the highly conductive material layer close to the transition zones from the substrate to the elongate resistor sections, whereby the local current density in the highly conductive material layer can still increase considerably. Furthermore, a thinning of the layer thickness of the highly conductive material layer in these transition zones will usually occur, which will likewise result in a considerable increase in the local current density, which nevertheless can and generally will have an adverse influence on the lifespan of the heating element.

### SUMMARY

The present disclosure describes several exemplary embodiments of the present invention.

One aspect of the present disclosure provides a heating element for use in a device for heating a medium, the heating element comprising an uninterrupted and integrally constructed track-like electrical resistor comprising a first material for forced conduction of electric current, wherein the electrical resistor comprises a plurality of elongate resistor segments and at least one curved resistor segment for mutual electrical coupling of the elongate resistor segments, wherein during operation of the heating element the local current density in at least a part of the at least one curved resistor segment is substantially higher than the local current density in the elongate resistor segments, wherein at least one curved resistor segment is at least partially provided with at least one highly conductive material layer manufactured from a second material, wherein the electrical conductivity of the second material is higher than the electrical conductivity of the first material

Another aspect of the present disclosure provides a device for heating a medium, the device, comprising a heating element comprising an uninterrupted and integrally constructed track-like electrical resistor comprising a first material for forced conduction of electric current, wherein the electrical resistor comprises a plurality of elongate resistor segments and at least one curved resistor segment for mutual electrical coupling of the elongate resistor segments, wherein during operation of the heating element the local current density in at least a part of the at least one curved resistor segment is substantially higher than the local current density in the elongate resistor segments, wherein at least one curved resistor segment is at least partially provided with at least one highly conductive material layer manufactured from a second material, wherein the electrical conductivity of the second material is higher than the electrical conductivity of the first material.

The present disclosure provides a heating element which obviates the above stated drawbacks while maintaining the advantage of the prior art.

The present disclosure provides a heating element comprising an uninterrupted and integrally constructed track-like electrical resistor manufactured from a first material for forced conduction of electric current, which electrical resistor comprises a plurality of elongate resistor segments and at least one curved resistor segment for mutual electrical coupling of the elongate resistor segments, wherein during operation of the heating element the local current density in at least a part of the at least one curved resistor segment is substantially higher than the local current density in the elongate resistor segments, which at least one curved resistor segment is at least partially provided with at least one highly conductive material layer manufactured from a second material, wherein the electrical conductivity of the second material is higher than the electrical conductivity of the first material. By applying a continuous and integrally constructed heating track instead of a plurality of discrete resistor sections which can be individualized, the critical transition zones from the elongate resistor segments to a possible substrate are no longer present, whereby the highly conductive material layer of substantially uniform thickness can be applied relatively accurately and easily to the heating track. Due to the absence of the critical transition zones, it will moreover be possible to avoid splitting of the material layer, whereby a significant increase in the local current density in the material layer can also be prevented. By applying the highly conductive material layer to at least a part of the at least one curved resistor segment it is precisely in these critical parts of the heating element that current crowding can be prevented. Electrons moving through the heating track will prefer the highly conductive material layer to (the inside bend of) the curved resistor segment itself. An additional advantage of applying a continuous heating track is that the heating track can already be tested as a whole for target resistance tolerances at an early stage during the production process, whereby malfunctioning heating elements can be detected and removed from the production process at a relatively early stage, i.e., before the production process is completed, which generally enhances the efficiency of the production process considerably.

Applying the highly conductive material layer to at least a part of the at least one curved resistor segment results in a parallel circuit of the highly conductive material layer and a part of the curved resistor segment connected to the material layer. The highly conductive material layer is preferably applied to the at least one curved resistor segment in substantially laminar manner. The layer thickness of the track-like electrical resistor and the highly conductive material layer applied thereto can differ from each other, but preferably lie in the order of magnitude of about 12 micrometers.

In order to enable optimization of the inflow of electric current into the highly conductive material layer, the highly conductive material layer is preferably provided with a relatively wide inflow opening. For this purpose, the highly conductive material layer preferably extends over substantially the full width of the curved resistor segment.

In one exemplary embodiment, the highly conductive material layer is at least applied to parts of the curved resistor segment adjacent to the elongate resistor segments. Such adjacent parts of the curved resistor segment generally have a relatively small radius of curvature, whereby the chance of current crowding is relatively great precisely in these parts.

In another exemplary embodiment, the highly conductive material layer is applied only to parts of the curved resistor segment adjacent to the elongate resistor segments. A part of the curved resistor segment located between the mutually adjacent parts will then not be provided with a highly conductive material layer. The parts of the curved resistor segment adjacent to the elongate resistor segments are generally separated from each other by a less curved or even linear part of the curved resistor segment, whereby this intermediate part of the curved resistor segment is less critical in respect of current crowding. Applying the highly conductive material layer to only the (most) critical parts of the curved resistor segment results in a material-saving which will be generally advantageous from an economic viewpoint. The highly conductive material layer preferably comprises silver. Although silver is relatively expensive, silver has a relatively good conductivity. A quantity of silver can be saved in each heating element by applying the material layer particularly selectively to the curved resistor segment. Particularly in the case of mass production of the heating element according to the present disclosure a considerable saving of material, in particular silver, can be realized within a determined time period.

The heating element of the present disclosure generally comprises a plurality of elongate resistor segments which are mutually coupled by respectively a plurality of curved resistor segments. In order to allow optimization of the design of the track-like electrical resistor, the elongate resistor segments will generally be oriented substantially parallel and preferably alongside each other. In this case, the curved resistor segment must be adapted to reverse the direction of the electric current, i.e., to change the direction of the current through an angle of substantially 180°. The curved resistor segments can then be divided (virtually and, in particular, functionally) into two sub-segments, wherein each sub-segment is adapted to change the direction of the current through an angle of substantially 90°. A less curved or non-curved sub-segment can optionally be positioned between these sub-segments for the purpose of determining the mutual distance between the mutually coupled, elongate resistor segments. As already noted, this intermediate sub-segment does not necessarily have to be provided with the highly conductive material layer.

Heating elements generally have a round geometry in top view. It is, therefore, advantageous if the elongate resistor segments are given an at least partially curved form, wherein the average radius of curvature of the elongate resistor segments is greater than the average radius of curvature of the curved resistor segments. In this manner, the elongate resistor segments can be given a substantially C-shaped form, wherein the elongate resistor segments are oriented in mutually concentric manner.

In another exemplary embodiment, the track-like electrical resistor is applied as thick film to a substantially electrically insulating substrate. The substrate is generally formed by a dielectric usually arranged on a carrier. The dielectric preferably comprises glass and/or ceramic. The dielectric is preferably provided with a heat-conducting support structure on a side remote from the track-like electrical resistor. The support structure preferably comprises a stainless steel plate. By manufacturing the support structure from a stainless steel material, the support structure is relatively corrosion-resistant. The support structure does not necessarily have to be positioned under the dielectric. In general, the support structure will be positioned just above the dielectric, wherein the support structure comes into direct contact with a liquid for heating.

The present disclosure also provides a device for heating liquids, wherein the device comprises at least one heating element according to the present disclosure. The device preferably also comprises a liquid container, in particular, a kettle. The above-mentioned support structure of the heating element preferably forms a part of the wall of the kettle. A liquid can thus be heated to a determined temperature relatively quickly in relatively effective manner.

### BRIEF DESCRIPTION OF THE DRAWINGS

Various aspects of the present disclosure are described hereinbelow with reference to the accompanying figures.

The present disclosure will be elucidated on the basis of non-limitative exemplary embodiments shown in the following figures.

FIG. 1 is a top view of a heating element according to the present disclosure;

FIG. 2a is a top view of a first exemplary embodiment of a detail of the heating element of FIG. 1;

FIG. 2b is a cross-section of the detail view shown in FIG. 2a;

FIG. 3a is a top view of a second exemplary embodiment of a detail of the heating element of FIG. 1;

FIG. 3b is a cross-section of the detail view shown in FIG. 3a;

FIG. 4a is a top view of a detail of a heating element known in the prior art;

FIG. 4b is a cross-section of the detail view shown in FIG. 4a; and

FIG. 5 is a cross-section of a water kettle provided with a heating element according to the present disclosure.

### DETAILED DESCRIPTION

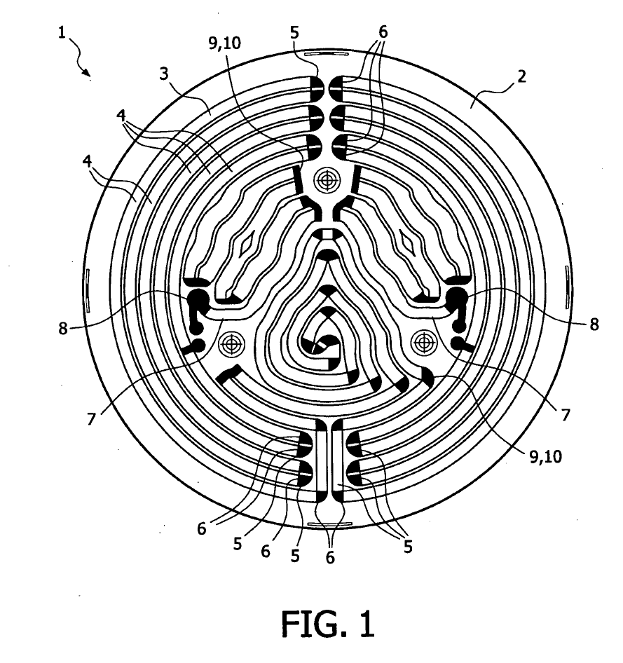

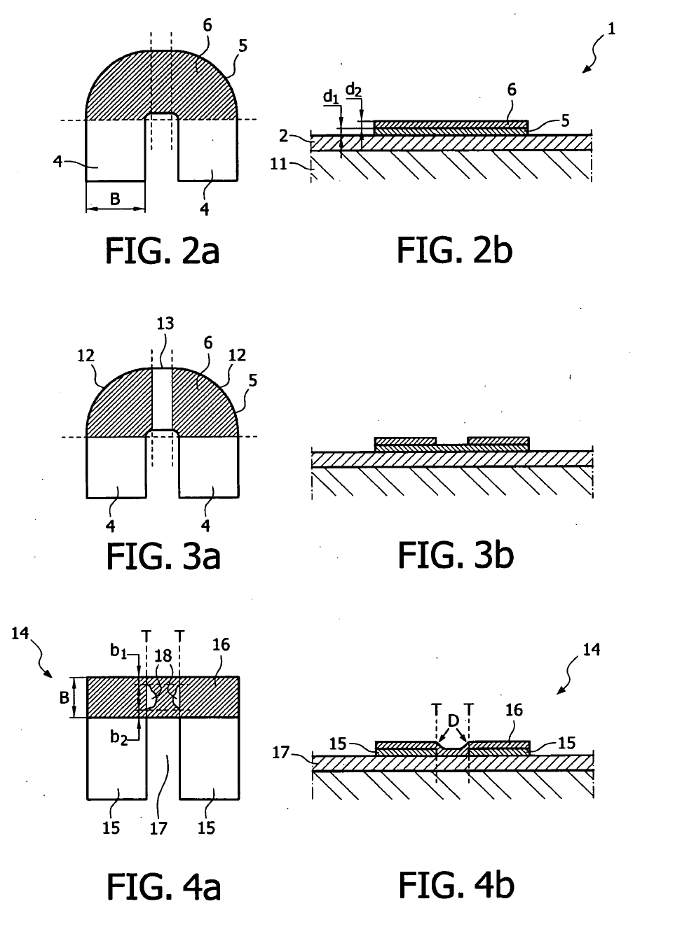

FIG. 1 shows a top view of a heating element 1 according to the present disclosure. Heating element 1 comprises a dielectric layer 2 to which a continuous (uninterrupted) heating track 3 is applied as thick film. Heating track 3 has an integral and uninterrupted construction. Heating track 3 comprises a plurality of elongate resistor segments 4 which are mutually connected by curved resistor segments 5. Since heating track 3 has an uninterrupted construction, this division has a more functional than structural nature. As shown clearly in FIG. 1, the elongate resistor segments 4 are also given a curved form, although the radius of curvature of the elongate resistor segments 4 is considerably greater than the radius of curvature of the curved resistor segments 5. The elongate resistor segments 4 are shown as C-shaped and oriented substantially concentrically to each other. In order to be able to prevent so-called current crowding in the curved resistor segments 5, the elongate resistor segments 4 are at least partially provided on one side with a silver, and thereby highly conductive, material layer 6. The dimensioning and design of this material layer 6 can be adapted to the design of heating track 3 as shown in FIGS. 2a-3b. The outer ends 7 of heating track 3 are each connected to their own terminal 8 for connecting heating element 1 to a power source (not shown). A centrical part of heating track 3 has a different layout, but each substantial curve or bend 9 is also provided with a silver material layer 10.

FIG. 2a shows a top view of a first exemplary embodiment of a detail of heating element 1 according to FIG. 1. Specifically shown are the outer ends of two substantially parallel and adjacently oriented elongate resistor segments 4, which are mutually connected by a curved resistor segment 5. The curved resistor segment 5 is adapted to reverse the direction of the current (through an angle of 180°). The whole upper surface of the curved resistor segment 5, i.e., the surface of the curved resistor segment 5 remote from dielectric layer 2, is covered by the silver material layer 6. As clearly shown, the silver material layer 6 extends over the full width B of resistor segments 4, 5. A somewhat smaller or greater width of the silver material layer 6 will, in all probability, also be sufficient to prevent current crowding in the curved resistor segment 5. The construction of heating element 1 is clearly shown in the cross-section shown in FIG. 2b. The top side of the curved resistor segment 5 is completely covered by the silver material layer 6. The thickness d₁ of the curved resistor segment 5 substantially corresponds to the thickness d₂ of the silver material layer 6 and generally lies in the order of magnitude of several micrometers. On a side of dielectric layer 2 remote from heating track 3 a stainless steel plate 11 is arranged to enable efficient heating of a liquid, and, in particular, water.

FIG. 3a shows a top view of a second exemplary embodiment of a detail of heating element 1 according to FIG. 1. In the exemplary embodiment shown here, the upper surface of the curved resistor segment 5 is covered only partially, though selectively, with the silver material layer 6. Only two curved (non-linear) sub-segments 12 of the curved resistor segment 5 which connect to the elongate resistor segments 4 are covered with the silver material layer 6, while an intermediate (linear) sub-segment 13 is left uncovered. A saving in the quantity of silver required can be realized in this way without detracting from the significant advantage to be gained by applying the silver material layer 6, this being favourable particularly from a financial viewpoint. The material saving to be realized is also shown in FIG. 3b.

FIG. 4a shows a top view of a detail of a heating element 14 known in the prior art. Heating element 14 comprises a plurality of discrete, elongate resistor segments 15 positioned a distance from each other. The elongate resistor segments 15 are mutually coupled by means of a silver bridge 16 arranged on resistor segments 15 and a part of an underlying dielectric 17 located between resistor segments 15. Owing to the cohesive forces of the silver bridge 16, however, gaps 18 usually occur on or close to the dividing line T between each elongate resistor segment 15 and the underlying dielectric 17, whereby the effective bridge width (b₁+b₂) at that position is only a fraction of the actual bridge width B. Current crowding and associated heat generation will, therefore, still be able to occur relatively quickly, which can significantly reduce the lifespan of heating element 14. It follows from the cross-section shown in FIG. 4b that the silver bridge 16 is relatively thin at the position of each dividing line T (see arrows D), which can also significantly increase the resistance of the silver bridge 16 and thereby the chance of current crowding, which is also undesirable. FIGS. 4a and 4b can be deemed as an embodiment of the heating element described in European Patent Application No. 1 013 148.

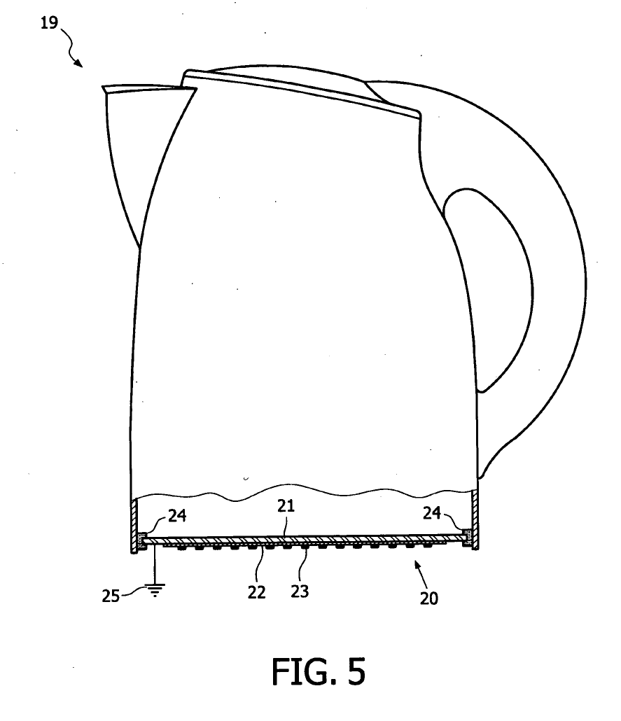

FIG. 5 shows a cross-section through a water kettle 19 provided with a heating element 20 according to the present disclosure. Heating element 20 can be formed by the heating element 1 shown in FIG. 1. Heating element 20 comprises an electrically conductive base plate 21. On the side remote from water kettle 19, base plate 21 is provided with a dielectric layer 22 on which electrical tracks 23 are arranged on the side remote from base plate 21. For an electrically insulated mounting of base plate 21 in water kettle 19, the edges of base plate 21 engage on an electrically insulating gasket 24. This insulating gasket 24 can optionally be omitted, for instance, when the jacket of water kettle in 19 is manufactured from an electrically insulating material. Base plate 21 is coupled to earth 25 for the purpose of earthing the liquid in water kettle 19.

It will be apparent that the invention is not limited to the exemplary embodiments shown and described here, but that numerous variants, which will be self-evident to a skilled person in this field, are possible within the scope of the appended claims.

All patents, patent applications and publications referred to herein are incorporated by reference in their entirety.

1.-15. (canceled)

16. A heating element for use in a device for heating a medium, the heating element comprising:
an uninterrupted and integrally constructed electrical resistor comprising a plurality of first resistor segments connected by at least a curved resistor segment, the resistor segments comprising a layer of a first conductive material;
the curved resistor segment further comprising a layer of a second conductive material over at least a portion of the layer of the first conductive material;
wherein the layer of the second conductive material reduces the current density in the layer of the first conductive material in the curved resistor segment.

17. The heating element of claim 16 wherein the second conductive material is more conductive than the first conductive material.

18. The heating element of claim 16, wherein the layer of the second conductive material layer is applied in a substantially laminar manner over the layer of the first conductive material.

19. The heating element of claim 16, wherein the layer of the second conductive material extends over substantially the full width of the curved resistor segment.

20. The heating element of claim 16, wherein the layer of the second conductive material extends over a portion of the curved resistor segment which is adjacent to a first resistor segment.

21. The heating element of claim 16, wherein the curved resistor segment comprises first sections having a first curvature and being adjacent to the first resistor segment, and a second section connecting the first sections, the second section either having substantially no curvature or having a curvature which is less than the first curvature.

22. The heating element of claim 16, wherein the first resistor segment is arranged in a substantially parallel orientation.

23. The heating element of claim 16, wherein at least one first resistor segment is at least partially curved.

24. The heating element of claim 16, wherein the average radius of curvature of the first resistor segment is greater than the average radius of curvature of the curved resistor segment.

25. The heating element of claim 16, wherein the layer of the second conductive material comprises silver.

26. The heating element of claim 16, wherein the electrical resistor is arranged on a substantially electrically insulating substrate.

27. The heating element of claim 26, wherein the insulating substrate comprises at least one of glass or ceramic.

28. The heating element of claim 26, wherein the insulating substrate is arranged on a thermally conductive support structure.

29. The hearing element of claim 28, wherein the support structure comprises a stainless steel plate.

30. A device for heating a medium, the device comprising:
a heating element comprising an uninterrupted and integrally constructed electrical resistor comprising a plurality of first resistor segments connected by a curved resistor segment, the resistor segments comprising a layer of a first conductive material;
the curved resistor segment further comprising a layer of a second conductive material over at least a portion of the layer of the first conductive material;
wherein the layer of the second conductive material reduces the current density in the layer of the first conductive material in the curved resistor segment.

31. The device of claim 30 wherein the second conductive material is more conductive than the first conductive material.

32. The device of claim 30, wherein the device further comprises a container for holding a liquid to be heated.

33. The device of claim 30, wherein the curved resistor segment comprises first sections having a first curvature and being adjacent to the first resistor segment and a second section connecting the first sections, the second section either having substantially no curvature or having a curvature which is less than the first curvature.

34. The device of claim 30, wherein the electrical resistor is arranged on a substantially electrically insulating substrate.

35. The device of claim 34, wherein the insulating substrate is arranged on a thermally conductive support structure.
